(19) United States
(12) Patent Application Publication
(10) Pub. No.: US 2015/0214700 A1
(43) Pub. Date: Jul. 30, 2015

(54) AC CIRCUIT BREAKER PANELS AND TELECOMMUNICATIONS EQUIPMENT CABINETS HAVING AC CIRCUIT BREAKER PANELS

(71) Applicant: Emerson Network Power, Energy Systems, North America, Inc., Warrenville, IL (US)

(72) Inventors: David Lee BERGERON, Lagrange, GA (US); Fred Douglas WALKER, JR., Lagrange, GA (US); Richard Arthur QUADE, Warrenville, IL (US); Steven Robert LATHAM, Aurora, IL (US)

(73) Assignee: Emerson Network Power, Energy Systems, North America, Inc., Warrenville, IL (US)

(21) Appl. No.: 14/167,718

(22) Filed: Jan. 29, 2014

(51) Int. Cl. H02B 1/32; H02H 3/22; H02H 7/22; H02H 3/16

(52) U.S. Cl. CPC H02B 1/32; H02H 3/162; H02H 3/22; H02H 7/22

(57) ABSTRACT

An AC circuit breaker panel includes a housing having a front side, a bus bar positioned in the housing, and one or more terminal blocks positioned in the housing. The housing has brackets adapted for mounting the AC circuit breaker panel to an equipment rack in a telecommunications equipment cabinet. The front side of the housing defines a plurality of openings for mounting a plurality of circuit breakers. The AC circuit breaker panel further includes a first circuit breaker mounted in one of the plurality of openings and wired to the bus bar, and a second circuit breaker mounted in one of the plurality of openings and wired to the bus bar and one of the terminal blocks. Further, a telecommunications equipment cabinet includes an equipment rack and one of the various AC circuit breaker panels disclosed herein.

### FIELD

The present disclosure relates to AC circuit breaker panels and telecommunications equipment cabinets having AC circuit breaker panels.

### BACKGROUND

This section provides background information related to the present disclosure which is not necessarily prior art.

AC circuit breaker panels are commonly used in telecommunications equipment cabinets for distributing AC power to various equipment via one or more protected circuits. These AC circuit breaker panels typically include circuit breakers and/or AC surge suppressors, as well as brackets adapted for mounting the AC circuit breaker panel to an equipment rack in a telecommunications equipment cabinet.

### SUMMARY

This section provides a general summary of the disclosure, and is not a comprehensive disclosure of its full scope or all of its features.

According to one aspect of the present disclosure, an AC circuit breaker panel includes a housing having a front side, a bus bar positioned in the housing, and one or more terminal blocks positioned in the housing. The housing has brackets adapted for mounting the AC circuit breaker panel to an equipment rack in a telecommunications equipment cabinet. The front side of the housing defines a plurality of openings for mounting a plurality of circuit breakers. The AC circuit breaker panel further includes a first circuit breaker mounted in one of the plurality of openings and wired to the bus bar, and a second circuit breaker mounted in one of the plurality of openings and wired to the bus bar and one of the terminal blocks.

According to another aspect of the present disclosure, an AC circuit breaker panel includes a housing having a front side, a first bus bar positioned in the housing, a second bus bar positioned in the housing, and a plurality of terminal blocks positioned in the housing. The housing has brackets adapted for mounting the AC circuit breaker panel to an equipment rack in a telecommunications equipment cabinet. The front side of the housing defines a plurality of openings for mounting a plurality of circuit breakers. The AC circuit breaker panel further includes a first circuit breaker mounted in one of the plurality of openings and wired to the first and second bus bars, and a second circuit breaker mounted in one of the plurality of openings and wired to the first and second bus bars and to two of the terminal blocks.

According to yet another aspect of the present disclosure, a telecommunications equipment cabinet adapted for outdoor use includes an equipment rack and one of the various AC circuit breaker panels disclosed herein.

Further aspects and areas of applicability will become apparent from the description provided herein. It should be understood that various aspects of the disclosure may be implemented individually or in combination with one or more other aspects. It should also be understood that the description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front perspective view of an AC circuit breaker panel according to one example embodiment of the present disclosure.

FIG. 2 is a front view of one example configuration of the circuit breaker panel of FIG. 1.

FIG. 3 is a top view of the circuit breaker panel of FIG. 2.

FIG. 4 is a rear perspective view of the circuit breaker panel of FIG. 2.

FIGS. 5 and 6 are front views of additional example configurations of the circuit breaker panel of FIG. 1.

FIG. 7 is a front perspective view of an AC surge protector mounted in an opening of the circuit breaker panel of FIG. 1.

FIG. 8 is a front view of an example telecommunications equipment cabinet having an AC circuit breaker panel mounted therein.

FIGS. 9-13 are wiring diagrams illustrating example configurations of the AC circuit breaker panels disclosed herein.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

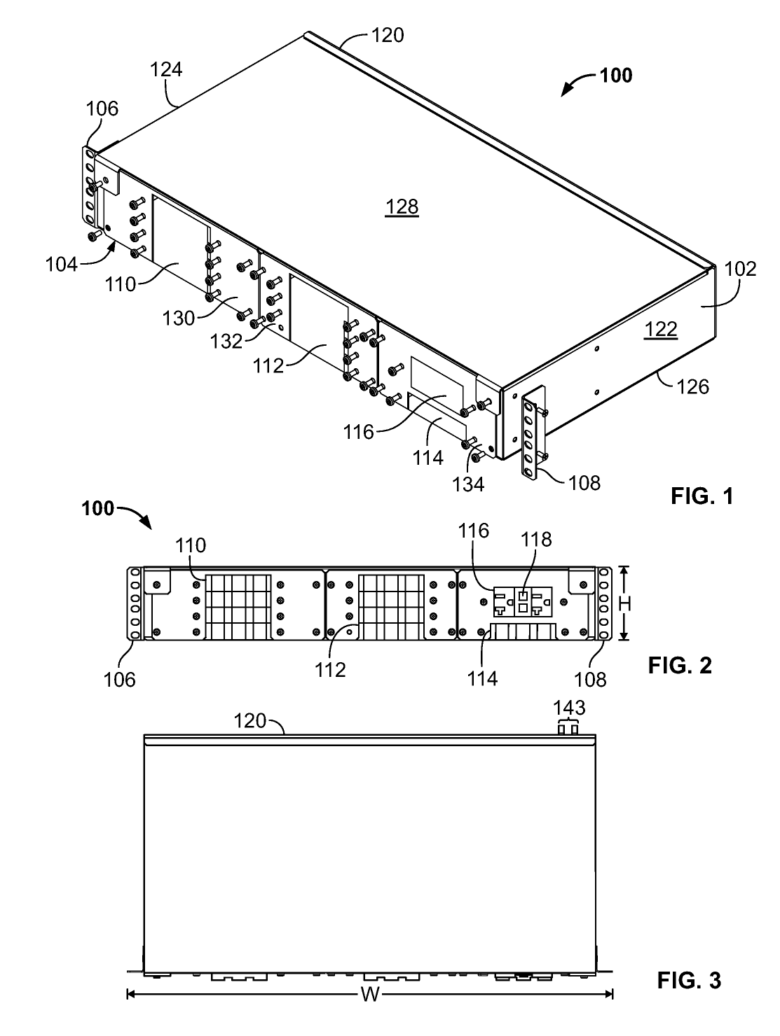

An AC circuit breaker panel according to one example embodiment of the present disclosure is illustrated in FIG. 1 and indicated generally by reference number 100. As shown in FIG. 1, the panel 100 includes a housing 102 having a front portion 104, and brackets 106, 108 adapted for mounting the AC circuit breaker panel to an equipment rack in a telecommunications equipment cabinet. The front portion 104 defines at least three openings 110, 112, 114, as shown in FIG. 1.

In the particular example shown in FIG. 1, the three openings 110, 112, 114 are arranged side-by-side, and each opening is adapted for mounting one or more circuit breakers therein. For example, openings 110, 112 are each adapted for mounting up to four 1-pole circuit breakers, two 2-pole circuit breakers, or a combination thereof. Opening 114 is adapted for mounting a single 1-pole breaker. An additional opening 116 provided above opening 114 is adapted for mounting a receptacle. In other embodiments, however, the panel 100 may be provided with more or less openings that are arranged as desired for a given application. For example, openings 114 and 116 can be replaced by a single opening adapted for mounting up to four 1-pole circuit breakers, two 2-pole circuit breakers, or a combination thereof. Further, any of the various openings may be adapted for mounting devices in addition to (or instead of) circuit breakers and receptacles. For example, one or more openings may be adapted for mounting an AC surge suppressor, as further explained below.

FIG. 2 illustrates an example configuration of the panel 100, where four 1-pole circuit breakers are mounted in opening 110, four 1-pole circuit breakers are mounted in opening 112, and a single 1-pole circuit breaker is mounted in opening 114. Additionally, a duplex receptacle 118 is mounted in opening 116. The receptacle 118 may be a ground fault interrupt (GFI) receptacle, as shown in FIG. 2.

The housing 102 may also include a rear portion 120, side portions 122, 124, a bottom portion 126, and a removable (or non-removable) top cover 128, as shown in FIG. 1.

In the example of FIG. 1, the front portion 104 of the housing is formed by three cover panels 130, 132, 134, with cover panel 130 defining the opening 110, cover panel 132 defining the opening 112, and cover panel 134 defining the openings 114, 116. Alternatively, the front portion of the housing and its openings may be formed using more or less cover panels, or without using cover panels (e.g., by forming the front portion 104 and the rear portion 120, side portions 122, 124, top cover 128 and/or bottom portion 126 from a single sheet of material, such as steel or another suitably conductive material.

As shown in FIG. 3, the panel 100 may have a width W of about twenty-three inches, so the panel 100 is mountable to a 23-inch equipment rack. Alternatively, the panel 100 may be provided with another suitable width, such as nineteen inches (e.g., so the panel 100 is mountable to a 19-inch equipment rack).

Further, the panel 100 preferably has a height H of about 3½ inches, as shown in FIG. 2, so the panel 100 will advantageously occupy only two rack units (2RU, also referred to as simply 2U) of space in the equipment rack of a telecommunications equipment enclosure.

Additionally, the AC circuit breaker panels disclosed herein preferably meet all applicable requirements for service equipment, including UL 869A, so one or more circuit breakers mounted to the panel 100 can be wired directly (i.e., with no intervening circuit breakers) to utility power, such as a utility meter, and function as main circuit breaker(s).

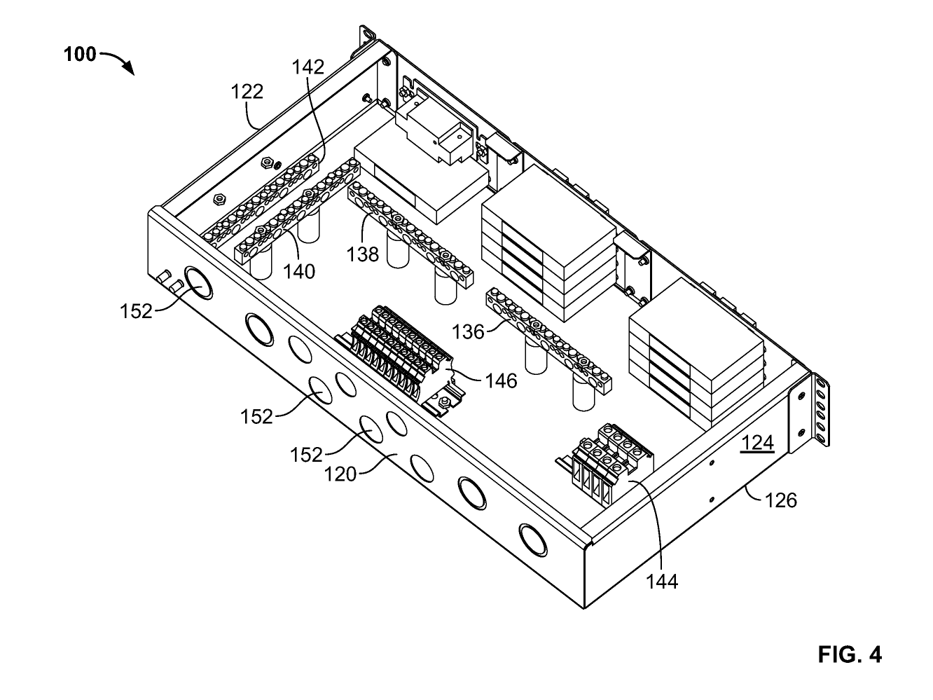

One or more bus bars and terminal blocks may be positioned in the housing 102. For example, FIG. 4 illustrates a panel 100 having four bus bars 136, 138, 140, 142 for making electrical connections to a first line voltage L1, a second line voltage L2, neutral, and ground, respectively. The L1, L2 and neutral bus bars may be spaced from the housing 102 using electrical isolators. The ground bus bar 142 may be electrically connected to the housing 102 and/or to ground terminals 143 provided on the rear portion 120 of the housing 102 (shown in FIG. 3).

The panel of FIG. 4 also includes four terminal blocks 144 for making input connections, and ten terminal blocks 146 for making output connections. The input terminal blocks 144 are mounted to a first DIN rail 148, and the output terminal blocks 146 are mounted to a second DIN rail 150. Alternatively, more or less DIN rails (including only one DIN rail) may be employed, or the terminal blocks 144, 146 may be mounted in the housing 102 without using DIN rails. Similarly, more or less bus bars and terminal blocks may be employed in any given implementation of these teachings. The bus bars are preferably spaced from conductive portions of the housing 102 using electrical isolators.

FIG. 4 also illustrates several knock-outs 152 on the rear portion 120 of the housing 102, which can be selectively removed to form wire passage openings through the rear portion 120 (i.e., for routing wires to/from the terminal blocks, bus bars and/or circuit breakers). While not shown in FIG. 4, knockouts can also (or instead) be provided on the side portions 122, 124, bottom portion 126 and/or top cover 128 (not shown in FIG. 4) of the housing 102 as may be desirable for a given implementation.

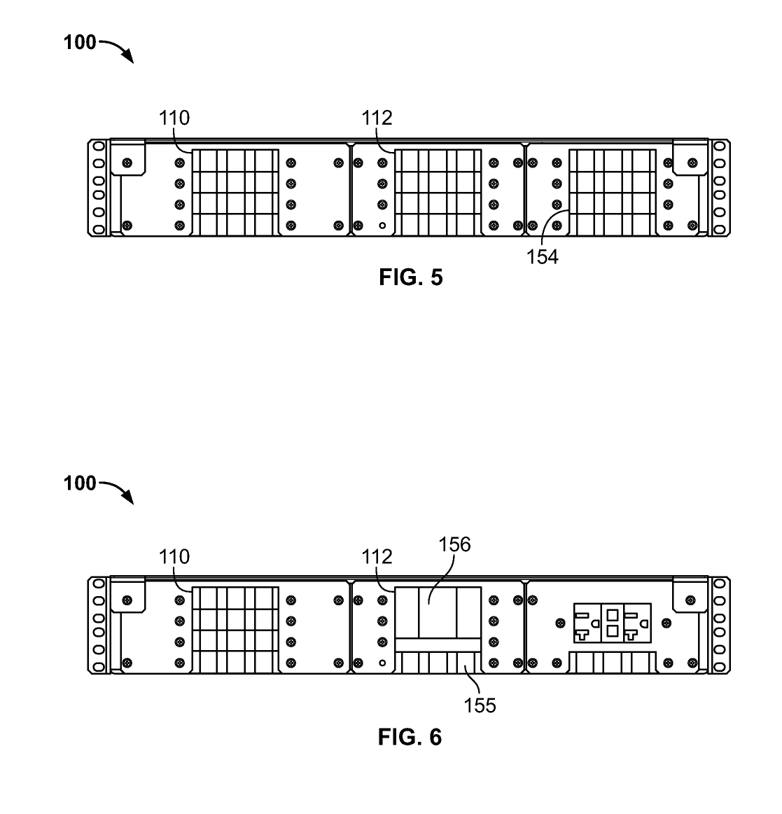

FIG. 5 illustrates an example configuration of the panel 100 similar to FIG. 2, except the openings 114, 116 in FIG. 2 are replaced by opening 154 in FIG. 5. Further, each of the openings 110, 112 and 154 in the example of FIG. 5 have four 1-pole circuit breakers, two 2-pole circuit breakers, or a combination thereof mounted therein.

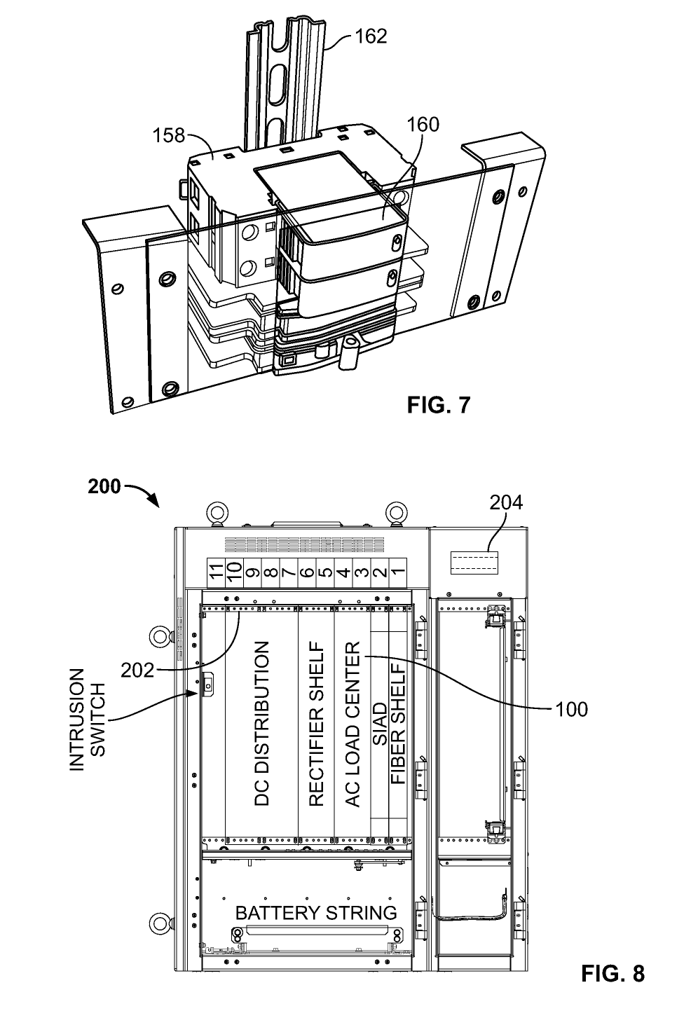

FIG. 6 illustrates another example configuration of the panel 100 similar to FIG. 2. However, in the example of FIG. 6, a single 1-pole circuit breaker 155 and an AC surge protector 156 are mounted in the opening 112. If the opening 112 is defined by a cover panel, such as cover panel 132 shown in FIG. 1, an additional cover plate (not shown) may be used to cover any open space between the surge protector 156 and the cover panel. As shown in FIG. 7, the AC surge protector 156 preferably has a multi-piece construction including a wired base portion 158 and a plug portion 160 that can be selectively coupled to and removed from the base portion 158—from a front side of the housing 102—without removing any wiring. Therefore, the plug portion 160 can be removed and replaced without requiring a qualified electrician. Preferably, the plug portion 160 can also be coupled to and removed from the base portion 158 without removing any cover panel, such as cover panel 132 shown in FIG. 1, and without removing the circuit breaker 155. An additional cover plate (if employed) may need to be removed before the plug portion 160 can be coupled to or removed from the base portion 158. Further, the AC surge protector 156 may be mounted in the opening 112 using a vertically oriented DIN rail 162, as shown in FIG. 7. The AC surge protector 156 may be a 240V AC surge protector.

Alternatively, the AC surge protector may be located external to the AC circuit breaker panel 100 and wired to the panel 100 as desired. For example, an external AC surge protector may be wired to a circuit breaker directly or via one or more output terminal blocks, wired to the L1 and L2 bus bars 136, 138, etc.

FIG. 8 illustrates one example embodiment of a telecommunications equipment cabinet 200 having an equipment rack 202 (comprising a pair of mounting rails) to which the AC circuit breaker panel 100 is mounted. While the panel 100 is shown mounted in a vertical orientation in the example of FIG. 7, the panel may instead be mounted in another orientation, including a horizontal orientation.

As shown in FIG. 8, the telecommunications equipment cabinet 200 may include a receptacle 204 mounted external to the AC circuit breaker panel 100. In that event, the AC circuit breaker panel 100 may include a circuit breaker wired to the receptacle 204. The receptacle 204 may be a GFI receptacle. Further, the receptacle 118 shown in FIG. 2 may be unnecessary and omitted from the AC circuit breaker panel 100.

The cabinet 200 is preferably a NEMA 3R type outdoor cabinet, and the equipment rack 202 in the cabinet is preferably a 23-inch or 19-inch rack.

With further reference to FIG. 8, the circuit breakers mounted to the front portion 104 of the AC circuit breaker panel 100 are preferably removable from a front side of the housing 102 when the AC circuit breaker panel 100 is mounted to the equipment rack 202. In other words, the circuit breakers can be removed and replaced from a front side of the housing 102 without removing the AC circuit breaker panel 100 from the cabinet 200. Similarly, if the panel 100 includes an AC surge protector 156, the plug portion 160 of the AC surge protector is preferably removable and replaceable from a front side of the housing 102, without removing the AC circuit breaker panel 100 from the cabinet 200.

If the AC circuit breaker panel 100 includes a main circuit breaker and a generator circuit breaker, a mechanical interlock is preferably employed so that at any given time, only the main circuit breaker or the generator circuit breaker is on, and not both. One example of a suitable interlock is the Square D type QOU2DTILA.

The AC circuit breaker panels described herein may employ NEMA Type 1 enclosures. In one example embodiment, the AC circuit breaker panel 100 may include up to twelve 1-pole circuit breakers, six 2-pole circuit breakers, or a combination thereof, optionally including main and generator 2-pole circuit breakers up to 100 A. Further, the panel 100 may be rated for an input voltage of up to 240V AC (50/60 Hz) and an input current of up to 100 A. The output/branch breakers may include 2-pole circuit breakers up to 60 A and/or 1-pole circuit breakers up to 30 A, and may have an interrupt rating of 10kAlC. Preferred breakers include Square D type QOU (UL File # E 84967), and preferred surge protectors include the pluggable base type (UL # VZCA & VZCA2). The input terminal blocks accept wire sizes 16 to 1/0 AWG (UL CCN # XCFR2), and the output terminal blocks accept wire sizes 24 to 4 AWG (UL CCN # XCFR2). The bus bars may include up to twelve positions for wire size 14 to 6 AWG, or five positions for wire size 14 to 1/0. Suitable bus bars include Eaton type BRGBK39512 or equivalent. Suitable bus isolators for spacing the bus bars from the housing 102 include NEMA Grade FR4 Glass Epoxy Laminate (UL CCN # QMTR2). The receptacles (when employed) may be 15 A or 20 A standard duplex type or GFI type.

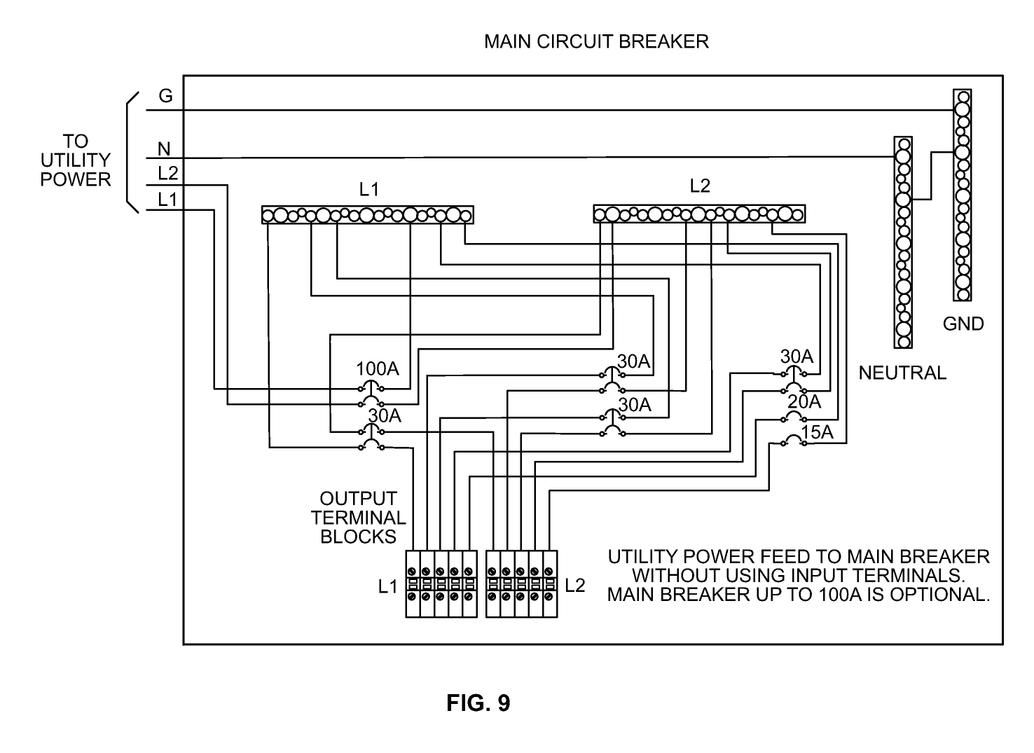

Some example wiring configurations for the AC circuit breaker panel 100 will now be described with reference to FIGS. 9-13.

In the example of FIG. 9, line voltages L1 and L2 are fed directly to a main 100 A 2-pole breaker without using terminal blocks. The main circuit breaker is also wired to L1 and L2 bus bars, which feed several branch circuit breakers, including four 30 A 2-pole 240 VAC circuit breakers, and two 1-pole 120 VAC circuit breakers (15 A and 20 A). The 1-pole circuit breakers may each be wired to receptacles external to the panel 100 (e.g., receptacles in the telecommunications equipment cabinet 200). The various branch breakers are wired to output terminal blocks. The neutral and ground lines from the utility source are wired to the neutral and ground bus bars, respectively. Further, the neutral bus bar is electrically coupled (e.g., wired) to the ground bus bar.

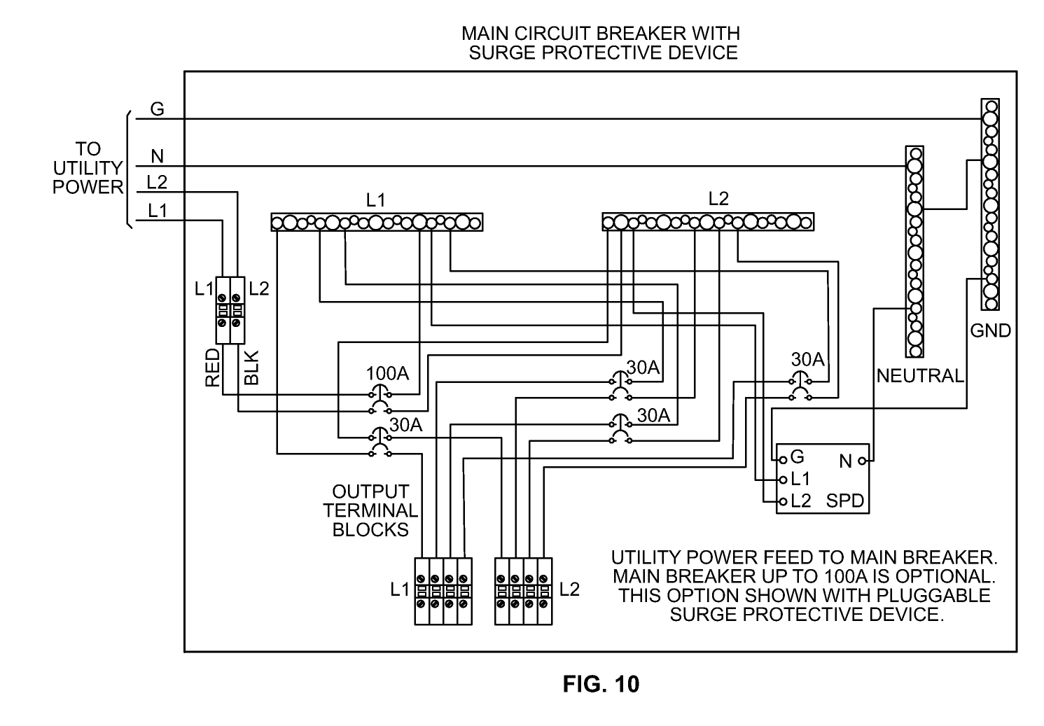

FIG. 10 illustrates an example similar to FIG. 9, except the main 100 A circuit breaker is connected to utility power via two input terminal blocks, and the circuit includes a 240 VAC surge protector wired to the L1, L2, neutral and ground bus bars.

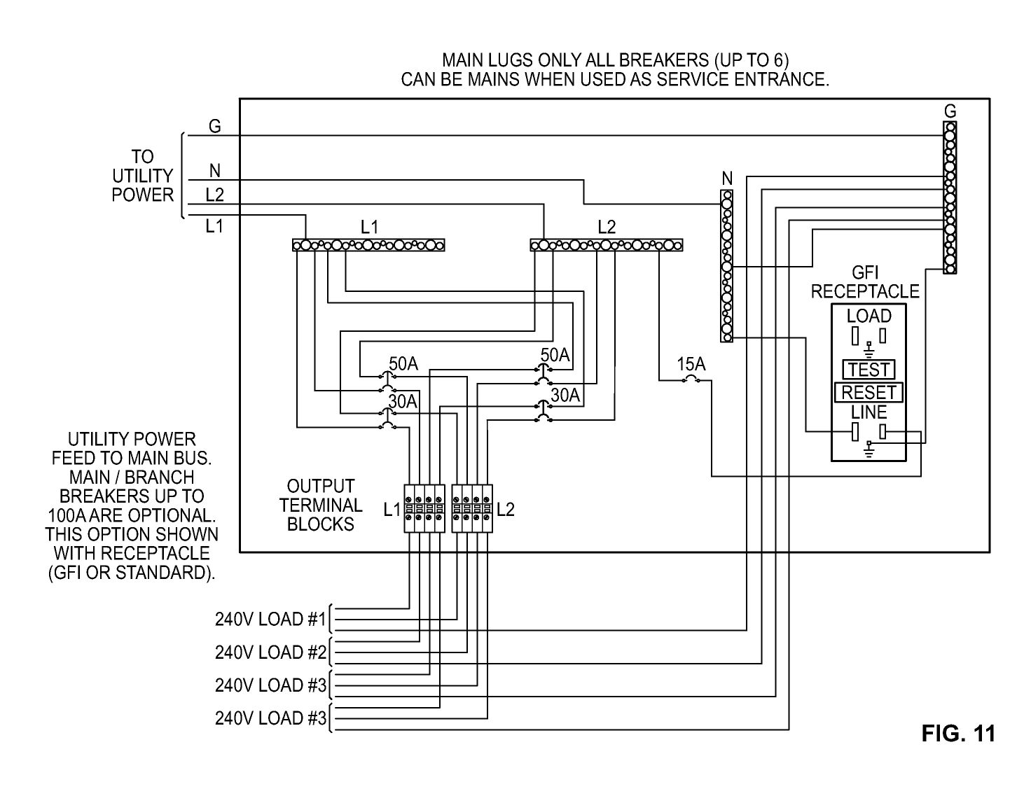

In the example of FIG. 11, line voltages L1 and L2 are fed directly to the L1 and L2 bus bars which, in turn, are wired to four 2-pole 240 VAC circuit breakers (two 50 A breakers and two 30 A breakers) and a 1-pole 120 VAC circuit breaker feeding a GFI receptacle in the panel 100.

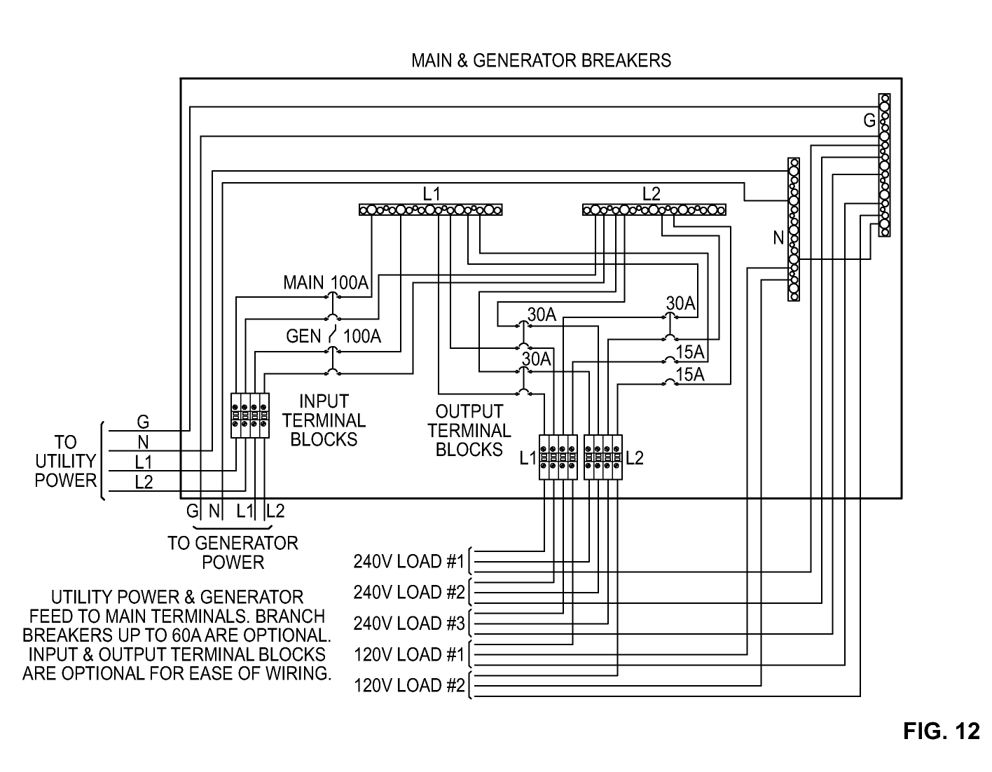

FIG. 12 illustrates an example similar to FIG. 9, except the main 100 A circuit breaker is connected to utility power via two input terminal blocks, and a generator 100 A circuit breaker is connected to generator power via two other input terminal blocks.

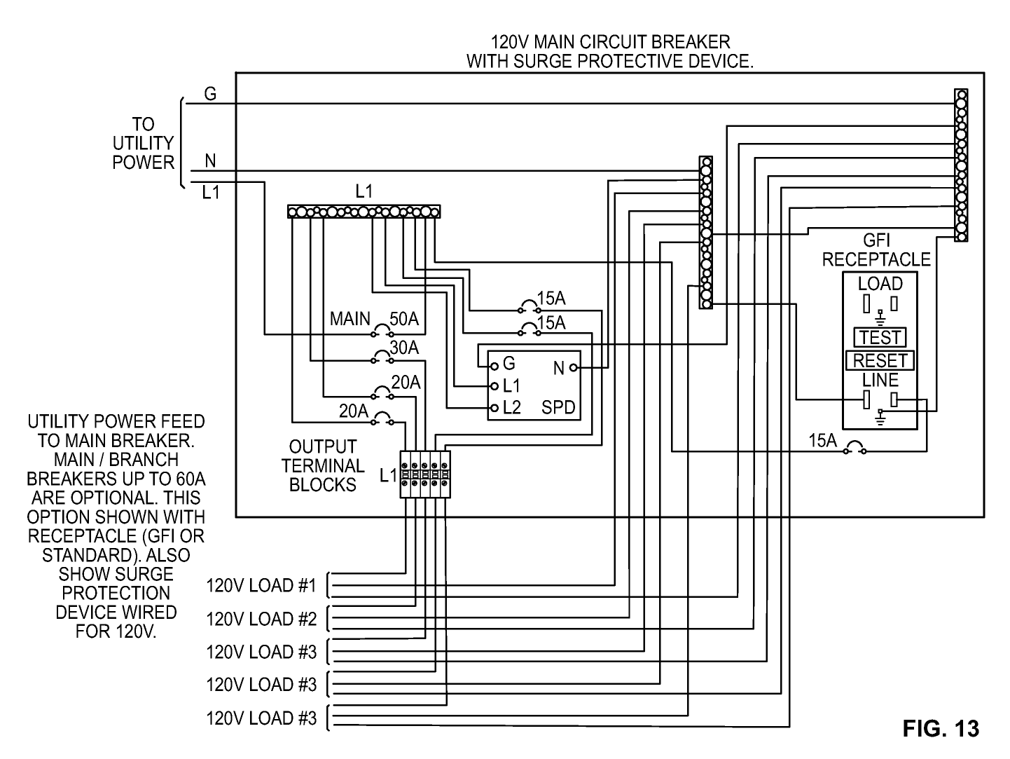

FIG. 13 illustrates a 120V example where line voltage L1 is fed directly to a main 50 A 1-pole circuit breaker without using terminal blocks. The main circuit breaker is also wired to the L1 bus bar, which feeds several 1-pole branch circuit breakers, including a 15 A breaker connected to a GFI receptacle in the panel 100. Additionally, an AC surge protector is coupled to the L1, neutral and ground bus bars. Except for the 15 A breaker feeding the GFI receptacle, the branch circuit breakers are wired to output terminal blocks. For this particular example, the L2 bus bar can be omitted.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An AC circuit breaker panel, comprising:
a housing having a front side, and brackets adapted for mounting the AC circuit breaker panel to an equipment rack in a telecommunications equipment cabinet;
the front side defining a plurality of openings for mounting a plurality of circuit breakers;
a bus bar positioned in the housing;
a first circuit breaker mounted in one of the plurality of openings and wired to the bus bar;
one or more terminal blocks positioned in the housing; and
a second circuit breaker mounted in one of the plurality of openings and wired to the bus bar and one of the terminal blocks.

2. The AC circuit breaker panel of claim 1, wherein the plurality of openings include a first opening, a second opening and a third opening, and wherein each of the first, second and third openings is sized to receive up to four single pole circuit breakers.

3. The AC circuit breaker panel of claim 1, wherein the AC circuit breaker panel qualifies as service equipment under applicable UL standards.

4. The AC circuit breaker panel of claim 1, wherein the first circuit breaker is a main circuit breaker wired directly to a utility meter.

5. The AC circuit breaker panel of claim 1, wherein the first circuit breaker is a main circuit breaker, and wherein one of the terminal blocks is wired directly to a utility meter and to the main circuit breaker.

6. The AC circuit breaker panel of claim 1, wherein the first circuit breaker is removable from said one of the plurality of openings from the front side of the housing when the AC circuit breaker panel is mounted to the equipment rack of a telecommunications equipment cabinet.

7. The AC circuit breaker panel of claim 1, further comprising an AC surge protector mounted in one of the plurality of openings.

8. The AC circuit breaker panel of claim 1, further comprising a receptacle mounted in one of the plurality of openings.

9. The AC circuit breaker panel of claim 8 wherein the receptacle is a GFI receptacle.

10. The AC circuit breaker panel of claim 9 further comprising a third circuit breaker wired to the bus bar and to the GFI receptacle.

11. The AC circuit breaker panel of claim 7, wherein the AC surge protector includes a plug portion and a wired base portion, and wherein the plug portion is removable and replaceable from the front side of the housing when the AC circuit breaker panel is mounted to the equipment rack of a telecommunications equipment cabinet.

12. The AC circuit breaker panel of claim 1, wherein the AC circuit breaker panel has a height dimension corresponding to two rack units (2RU).

13. The AC circuit breaker panel of claim 1, wherein the first circuit breaker and the second circuit breaker are 2-pole circuit breakers.

14. The AC circuit breaker panel of claim 1, wherein the brackets are adapted for mounting the AC circuit breaker panel to a 23-inch equipment rack.

15. An AC circuit breaker panel, comprising:
a housing having a front side, and brackets adapted for mounting the AC circuit breaker panel to an equipment rack in a telecommunications equipment cabinet;
the front side defining a plurality of openings for mounting a plurality of circuit breakers;
a first bus bar positioned in the housing;
a second bus bar positioned in the housing;
a first circuit breaker mounted in one of the plurality of openings and wired to the first and second bus bars;
a plurality of terminal blocks positioned in the housing; and
a second circuit breaker mounted in one of the plurality of openings and wired to the first and second bus bars and to two of the terminal blocks.

16. A telecommunications equipment cabinet adapted for outdoor use, the cabinet comprising:
an equipment rack; and
the AC circuit breaker panel of claim 1 mounted to the equipment rack.

17. The cabinet of claim 16 further comprising a receptacle mounted in the cabinet external to the AC circuit breaker panel, wherein the AC circuit breaker panel includes a circuit breaker wired to the receptacle.

18. The cabinet of claim 17 wherein the receptacle is a GFI receptacle.

19. The cabinet of claim 16 wherein the AC circuit breaker panel is mounted in the cabinet in a vertical orientation.

20. The cabinet of claim 16 wherein the cabinet is a NEMA 3R type outdoor cabinet.

21. The cabinet of claim 16 wherein the equipment rack is a 23-inch rack.
